(19) United States
(12) Patent Application Publication
(10) Pub. No.: US 2013/0338823 A1
(43) Pub. Date: Dec. 19, 2013

(54) VENDING SYSTEM AND METHOD OF SELLING COMMERCIAL PRODUCTS

(71) Applicant: ILLINOIS TOOL WORKS INC., Glenview, IL (US)

(72) Inventors: Thomas Letizia, Wheaton, IL (US); Deborah J. Ashton, Tonawanda, NY (US)

(73) Assignee: ILLINOIS TOOL WORKS INC., Glenview, IL (US)

(21) Appl. No.: 13/793,835

(22) Filed: Mar. 11, 2013

Related U.S. Application Data
(60) Provisional application No. 61/661,686, filed on Jun. 19, 2012.

(51) Int. Cl. G07F 11/00

(52) U.S. Cl. CPC G07F 11/00
USPC 700/237

(57) ABSTRACT

A vending system including a machine housing having an operative side configured to interface with an individual. The vending system also includes a product dispenser supported by the machine housing. The product dispenser is configured to dispense a controlled product. The vending system also includes an imaging system that is configured to capture visual data when the individual is positioned proximate to the operative side. The visual data includes a present image of the individual and a card image of the identification card. The identification card includes a personal image of a person. The vending system also includes a computing system that is configured to analyze the visual data to determine whether the person in the personal image is the individual positioned proximate to the operative side. The computing system is also configured to determine whether the individual is permitted to purchase the controlled product.

### CROSS-REFERENCE TO RELATED APPLICATIONS

The present application claims the benefit of U.S. Provisional Application No. 61/661,686 (“the '686 Application”), filed on Jun. 19, 2012 and entitled “VENDING SYSTEM AND METHOD OF SELLING COMMERCIAL PRODUCTS.” The subject matter of the '686 Application is incorporated herein by reference in its entirety.

### BACKGROUND

Many products available for point-of-sale (POS) purchases are regulated or controlled in some manner. For example, tobacco and alcoholic products may only be sold to individuals who are a designated age (e.g., 18 or 21). Likewise, some games and movies may only be sold to individuals above a certain age. In addition to age requirements, the sale of firearms may be limited to those individuals who previously acquired a permit. As another example, sales of certain medications (e.g., medications that include pseudoephedrine) may be controlled so that one individual is not permitted to obtain an excessive amount of the medication.

In each of the above cases, the retailer selling the controlled product may be required to verify that the individual is permitted to purchase the controlled product. For instance, a sales clerk may be required to review an identification card (e.g., driver's license) of the individual attempting to purchase the controlled product to determine the age of the person. A pharmacist may be required to review or confirm with, for example, a statewide database that the individual has not previously purchased the medication such that the current purchase would exceed a designated amount within a designated time period. In the above examples, the retailer must spend time to confirm that the sale is permitted. This time may otherwise be used for other purposes (e.g., assisting other customers or checking out other purchasers). Moreover, when determining whether the individual is permitted to buy a product, human error may inadvertently allow a transaction to occur when it should not permitted. For example, the individual attempting to purchase the controlled product may have an identification card that is not authentic (e.g., a fake ID) or that is expired.

Vending machines are systems that provide products to an individual after receiving or confirming that a designated amount of money is paid. Vending machines include devices for receiving physical currency (e.g., coins or bills) and/or devices for obtaining data from a credit card. However, in some cases, an individual may not have the correct amount of physical currency or may not have a credit card. In such cases, it may be desirable to have other methods for obtaining payment from an individual.

Moreover, vending machines are typically self-contained systems that are operated independently from other systems. Communication of a vending machine with another system(s) may be limited to, for example, confirmation that a credit card company will allow payment. In some cases, it may be desirable to communicate with the vending machine to obtain data regarding the status of the vending machine, data about the sales of the commercial products, and/or data about the individuals who made the purchases.

### BRIEF SUMMARY

In one embodiment, a vending system is provided that includes a machine housing having an operative side configured to interface with an individual. The vending system includes a product dispenser that is supported by the machine housing and configured to dispense a controlled product. The vending system also includes an imaging system that is configured to capture visual data when the individual is positioned proximate to the operative side. The visual data includes a present image of the individual and a card image of the identification card. The identification card includes a personal image of a person. The vending system also includes a computing system that is configured to analyze the visual data to determine whether the person in the personal image is the individual positioned proximate to the operative side. The computing system is also configured to determine whether the individual is permitted to purchase the controlled product.

In another embodiment, a method of verifying that an individual is permitted to purchase a controlled product at a vending system is provided. The method includes capturing visual data of the individual that is positioned proximate to an operative side of the vending system. The visual data includes a present image of the individual and an identification card. The identification card includes a personal image of a person. The method also includes analyzing the visual data to determine whether the person in the personal image is the individual positioned proximate to the operative side. The method also includes determining whether the individual is permitted to purchase the controlled product.

In another embodiment, a vending system is provided that includes a machine housing having an operative side configured to interface with an individual. The vending system also includes a product dispenser that is supported by the machine housing and is configured to dispense a commercial product. The vending system also includes a near-field communication device that is configured to communicate with a portable electronic device of the individual. The near-field communication device is configured to receive transactional data from the portable electronic device for completing a commercial transaction to purchase the controlled product. The vending system also includes a payment-verification module that is configured to communicate with a financial entity to confirm payment of the transaction.

In yet another embodiment, a vending system is provided that includes a machine housing having an operative side that is configured to interface with individuals during transactions in which commercial products are sold to the individuals. The vending system also includes a product dispenser that is supported by the machine housing and that is configured to dispense the commercial products to the individuals. The vending system also includes a sales-recording module that is configured to store sales data relating to the commercial products sold through the transactions. The vending system also includes an analysis module that is configured to analyze the sales data. The analysis module is configured to determine at least one of: (a) whether a first product-of-interest is sold out or has only a limited number remaining for sale; (b) an amount of tax owed for sales of the commercial products; and (c) an updated price of a second product-of-interest based on a number of sales of the second product-of-interest in a designated time period.

### BRIEF DESCRIPTION OF THE DRAWINGS

Reference is now made briefly to the accompanying drawings, in which:

FIG. 1 is a schematic diagram of a vending system in accordance with one embodiment; and

FIG. 2 illustrates an operative side of a vending system formed in accordance with one embodiment.

### DETAILED DESCRIPTION

Embodiments described herein include vending systems and methods that are configured to conduct point-of-sale (POS) transactions with individuals. During a transaction, an individual, who may also be referred to as a consumer, purchaser, or customer, may provide payment at the vending system and receive a commercial product from the vending system. The vending system may also be characterized as a vending machine, kiosk, or terminal. Commercial products may include any tangible goods that are available for purchase. The commercial products are typically suitable for being stored over extended periods of time and typically sized such that a plurality of the commercial products may be stored in the vending system. In some embodiments, an individual may communicate with a user interface of the vending system to select a desired product among other available products and to provide payment for the product.

In particular embodiments, the commercial products are controlled or regulated products in which sale of the products are restricted or limited in some manner. Controlled products may be commercial products in which laws and/or regulations in a jurisdiction only permit the products to be sold or used by individuals who satisfy one or more requirements. As non-limiting examples, controlled products may include alcoholic products, tobacco products, drug products, firearms, and entertainment/media products (e.g., games or movies that are permitted to be purchased by individuals over a designated age). By way of example only, the one or more requirements may relate to an age of the customer, a criminal history of the customer, a mental history of the customer, and whether a purchase of the controlled product would exceed an amount of the controlled product that is permitted to be purchased within a designated time period. In some cases, during the commercial transaction of a controlled product, the vending system may only permit the sale of the controlled product if the individual provides suitable evidence that the individual is permitted to purchase the controlled product. For example, the vending system may read or scan an identification card (e.g., driver's license, passport, and the like) from the individual and analyze the identification card to at least one of: determine whether the identification card is valid, determine that the individual is the person in the identification card, or determine that the individual is permitted to purchase the product.

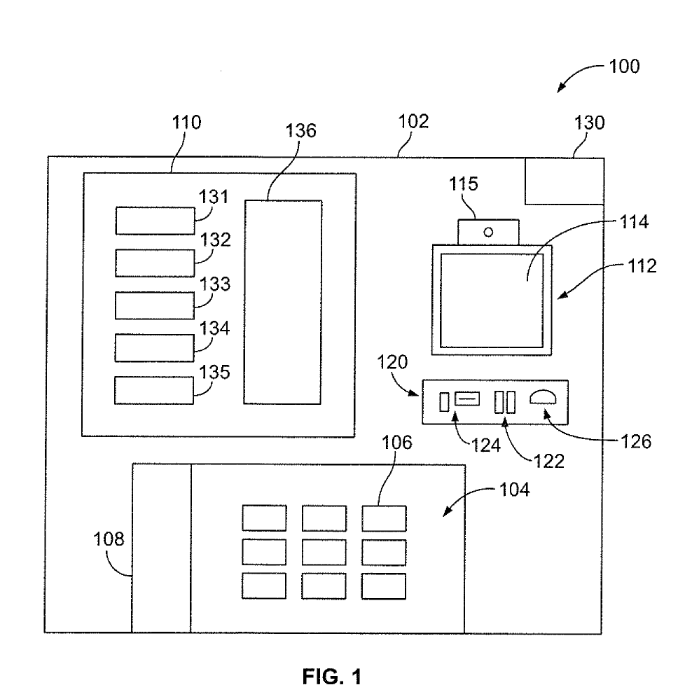

FIG. 1 is a schematic diagram of a vending system 100 formed in accordance with one embodiment. The vending system 100 includes a machine housing or structure 102 that is configured to support one or more elements of the vending system 100. In some embodiments, the machine housing 102 is dimensioned to be a self-contained or stand-alone unit that is transportable to various locations. By way of example only, the machine housing 102 may be substantially rectangular and be dimensioned (e.g., 6 ft×4 ft×4 ft) to hold the products as well as systems/devices that facilitate selling the products and/or obtaining data about the sales. The vending system 100 may be rolled on wheels as a unit or carried as a unit using, for example, a fork lift. In some embodiments, the vending system 100 includes a locator 130 that enables tracking of the vending system. The locator 130 may be used to confirm that a plurality of vending systems are located appropriately and/or to track the vending systems if any are stolen. The locator 130 may be, for example, a global positioning system (GPS) device. However, in other embodiments, the vending system 100 may not be readily transported as a unit. For example, the vending system 100 may be at least partially integrated in the wall of a retail store. In such embodiments, the products sold by the vending system 100 may be restocked from behind the wall.

The machine housing 102 may include a storage space 104 where a plurality of commercial products 106 are stored and a product dispenser 108 that is configured to provide the product 106 to the individual purchasing the product 106. The products 106 may be controlled products as described above. However, in some embodiments, the products 106 are non-controlled products. Non-controlled products may be purchased by any person who can provide payment. In some cases, the storage space 104 is exposed or is viewable by an individual (e.g., potential customer). For example, the individual may be able to view into the storage space 104 through a window and determine that there is at least one product of a certain type remaining. In other embodiments, the storage space 104 is not viewable by the individual.

The vending system 100 may also include a computing system 110 and a user interface 112. The computing system 110 includes one or more processors/modules configured to instruct the various elements (e.g., components, assemblies, devices, and systems) of the vending system 100 to operate in a designated manner during, for example, a commercial transaction. The computing system 110 is configured to execute a set of instructions that are stored in one or more storage elements (e.g., instructions stored on a tangible and/or non-transitory computer readable storage medium) to control operation of the vending system 100. The set of instructions may include various commands that instruct the computing system 110 as a processing machine to perform specific operations such as the workflows, processes, and methods described herein.

A commercial transaction may include a product-selection stage in which the individual selects a commercial product for purchasing and, optionally, a validation stage, wherein the computing system 110 determines whether the individual is permitted to purchase the product. A commercial transaction may also include a payment stage in which the individual transfers payment to the vending system (or owner of the vending system). The various stages of the commercial transaction may occur before, after, or (in some cases) during the other stages.

The user interface 112 is configured to receive user inputs and display information to the individual during the commercial transaction. The user interface 112 may include hardware, firmware, software, or a combination thereof that enables an individual (e.g., the customer, purchaser, consumer, and the like) to directly or indirectly control operation of the vending system 100 and the various components thereof. As shown, the user interface 112 includes a customer display 114. In some embodiments, the user interface 112 may also include one or more input devices (not shown), such as a physical keypad, keyboard, mouse, and/or touchpad. In an exemplary embodiment, the customer display 114 is a touch-sensitive display (e.g., touchscreen) that can detect a presence of a touch from an individual that is interacting with the vending system 100 and can also identify a location in the display area of the touch. The touch may be applied by, for example, at least one of an individual's hand, glove, stylus, or the like. As such, the touch-sensitive display may receive inputs from the individual and also communicate information to the individual.

The user interface 112 is configured to receive user inputs from the individual. The user inputs may include instructions or commands from the user to purchase a desired product. For example, the user inputs may include commands that the individual would like to purchase one product among other available products. The user inputs may be answers to requests from the vending system 100. For example, the vending system 100 may request that the individual provide information that facilitates completing the commercial transaction (e.g., the individual may identify the product that the individual would like to purchase, the method of payment, etc.). The individual may also provide personal information (e.g., age, mailing address, email address, etc.) when prompted by requests from the vending system 100. The requests may be displayed on the customer display 114.

The vending system 100 may include an imaging system 115. The imaging system 115 includes at least one imager (e.g., CMOS, CCD, and the like) that is configured to image (e.g., obtain still frames or video) of an individual during the commercial transaction and, in particular, during the validation stage. The imaging system may be configured to image the individual proximate to an operative side of the vending system 100. The operative side may be, for example, a side of the vending system 100 wherein the user interface 112 is accessible to the individual. As will be described in greater detail below, the imaging system 115 may obtain an image of the individual that is attempting to make a purchase of a commercial product and also an image of evidence that may be used to support that the individual is permitted to purchase the product. In such embodiments, the validation stage may be referred to as the image-acquisition stage.

The vending system 100 may include a payment-receiving apparatus or system 120 that is configured to receive payment from the individual for one or more of the commercial products 106. The payment-receiving system 120 may be configured to accept only one type of payment method (e.g., credit card) or may be configured to accept multiple types of payment methods. For example, the payment-receiving system 120 may include a card reader 122, a currency receiver 124, and a near-field communication device 126. The card reader 122 may be configured to scan or read a magnetic strip or other readable medium of, for example, a bank card. The currency receiver 124 may include coin slots and/or bill acceptors that are configured to receive physical currency.

The near-field communication device 126 may be configured to communicate with a portable electronic device (e.g., phone, tablet computer, or notebook computer). For example, the near-field communication device 126 may communicate wirelessly (e.g., via radio waves) with the portable electronic device. The near-field communication device 126 may be configured to receive transactional data from the portable electronic device for completing a commercial transaction to purchase the product 106. The payment may be made according to an established or recognizable mobile payment protocol, such as Google Wallet™. In some embodiments, the near-field communication device 126 may include an imager (e.g., CMOS or CCD camera) that is configured to capture an image of the electronic device. The image of the electronic device may include an encoded feature that represents at least a portion of the transactional data that is necessary for carrying out the commercial transaction. By way of example only, the electronic device may have a device display that shows a barcode (e.g., conventional bar code or QR code). The bar code may be used in processing payment for the product. In some embodiments, the electronic device may also have physical or visible features that are located on the housing of the electronic device and provide at least a portion of the transactional data.

In some embodiments, the user interface 112 may be a part of the payment-receiving system 120 or operate in conjunction with the system 120, wherein the user interface 112 enables the individual to transfer payment from a financial entity to the owner of the vending system 100. For example, the user interface 112 may operate as a portal to the Internet, wherein the individual can access a webpage (e.g., PayPal® or webpage of banking institution) and instruct for payment to be made.

The product dispenser 108 may be supported by the machine housing 102 and configured to dispense to the individual one or more of the commercial products 106. The product dispenser 108 may be activated (or actuated) after the vending system 100 has confirmed that the individual has provided sufficient payment and, optionally, satisfies one or more requirements. The product dispenser 108 may include one or more structural elements that are configured to operate in a designated manner to provide the product 106. For instance, the product dispenser 108 may include a door or flap that is selectively opened and closed to allow the commercial product to fall toward a designated chamber where the product 106 may be collected by the individual. The product dispenser 108 may also include a robotic arm that is controlled by, for example, the computing system 110 to selectively grip and move the product 106 to a designated location where the product 106 may be collected. However, the above-described elements of the product dispenser 108 are only exemplary and the product dispenser 108 may include additional or alternative components that operate to provide the product 106 to the individual.

The computing system 110 may include one or more modules that are configured to perform various functions or operations of the vending system 100. For example, the computing system 110 may include an image-analysis module 131, a data-analysis module 132, a payment-verification module 133, a sales-recording module 134, and an interface module 135. The computing system 110 may also include a storage device 136 that is configured to communicate with and store data that is provided by or provided for the modules 131-135. Each of the modules 131-135 may be part of a single controller or microprocessor or be part of multiple controllers. The modules 131-135 may also be located in a common controller or be distributed within multiple controllers. Moreover, the modules 131-135 are not required to be located within the machine housing 102. For example, at least a portion of the payment-verification module 133 may be located remotely, such as with a central server system.

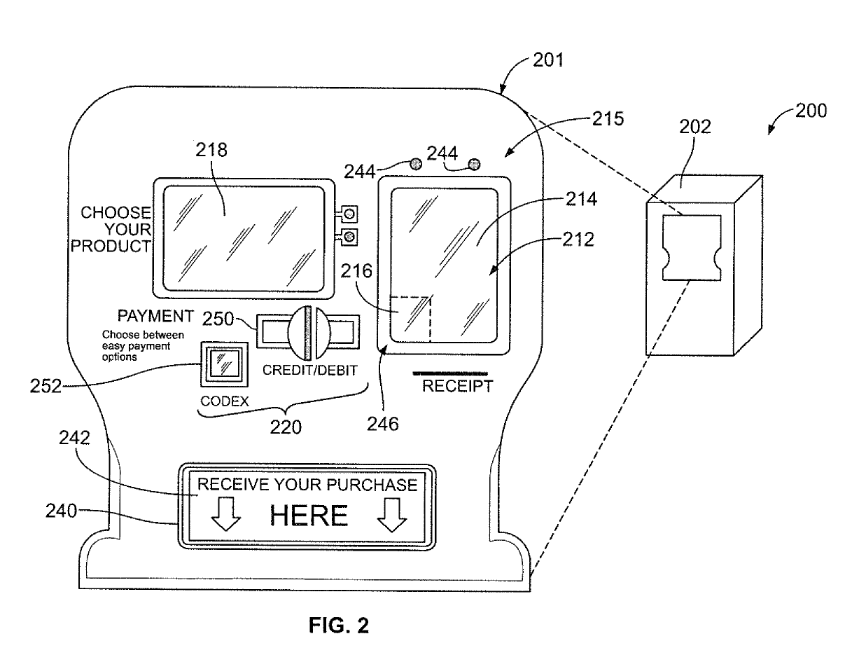

The operation and at least some of the capabilities of the modules 131-135 are described in greater detail below with respect to the vending system 200 (FIG. 2). In some embodiments, the vending systems 100 and 200 are configured to verify/validate that the individual attempting to purchase a controlled product satisfies one or more rules (e.g., from laws and/or regulations) that restricts sale of the controlled product. In some embodiments, the vending systems 100 and 200 permit payment using a portable electronic device, such as a smart phone or tablet computer. In some embodiments, the vending system 200 stores data regarding the sales of the various products and analyzes the data to (a) inform an operator/owner of the vending system that a product-of-interest is sold out or has only a limited number remaining for sale; (b) communicate an amount of tax owed for sales of certain products; or (c) calculate a new price for a product-of-interest based on a number of sales of the product-of-interest and/or a number of remaining products-of-interest.

FIG. 2 illustrates an operative side 201 of a vending system 200 formed in accordance with one embodiment. The vending system 200 has similar features as the vending system 100 and is configured to operate in a similar manner. For example, the vending system 202 includes a machine housing 202, a payment-receiving system 220, an imaging system 215, and a user interface 212. Although not shown, the vending system 200 also includes a product dispenser, which will be referred to as the product dispenser 108 hereinafter, and a computing system, which will be referred to as the computing system 110 hereinafter. The product dispenser 108 is configured to provide a commercial product to a product chamber 240 that is accessible through a door 242 of the machine housing 202.

In particular embodiments, the vending system 200 is configured to sell controlled products. In such embodiments, the vending system 200 may obtain evidence (e.g., identification information, images/pictures of the individual) to determine if the individual satisfies one or more rules regarding the sale of the controlled products. For example, the user interface 212 includes a customer display 214, a card screen 216, and a touchscreen 218. In the illustrated embodiment, the customer display 214 and the card screen 216 are each portions of a continuous screen (e.g., a common surface of glass or plastic). In other embodiments, the touchscreen 218 may also be part of the continuous screen. In alternative embodiments, each of the customer display 214, the card screen 216, and the touchscreen 218 has a separate screen.

The customer display 214 and/or the touchscreen 218 may be configured to show at least one of a graphical user interface (GUI) element, a single image frame of the individual, or a video of the individual. In the illustrated embodiment, the customer display 214 is configured to display the image frame or the video of the individual. During the image-acquisition stage, the customer display 214 shows the individual how he or she is being viewed by the imaging system 215 for capturing a present image of the individual. The present image may be a single image frame, a plurality of image frames (e.g., a series of frames that are captured 2/second, 5/second, 24/second, etc.), or a video of the individual. In other words, the present image may be a real-time video of the individual positioned proximate to the operative side 201. The present image is analyzed by the computing system 110 to determine if the individual may purchase a product. In some embodiments, the customer display 214 may also show commands and/or requests for the individual to perform particular actions.

In one embodiment, the customer display 214 also may acquire images. For example, the customer display 214 may represent a light transmissive object (e.g., a glass or light transmissive plastic screen) with a camera or other image acquiring device disposed behind the display 214. The display 214 may concurrently acquire images of the individual and the identification card. For example, the individual may place his or her identification card against the display 214 while the camera or image acquiring device scans both the card and an image of the individual standing behind the card at a different distance from the display 214 than the card.

The imaging system 215 may include one or more cameras 244. The imaging system 215 may also include an image scanner 246. The image scanner 246 may be similar to scanners that are used to image documents and/or pictures. The image scanner 246 may also be a camera that is similar to the cameras 244. During the image-acquisition stage, the identification card of the individual may be pressed immediately adjacent to the card screen 216. For example, the identification card may be pressed against the card screen 216 and/or held adjacent to the card screen 216 without touching. A card image of the identification card may be captured before, after, or while the present image of the individual is obtained. In some embodiments, the card image and the present image of the individual may be combined in a composite image. In some embodiments, the card image and the present image are captured using the same camera.

During a product-selection stage, the person may position himself or herself proximate to the operative side 201. The computing system 110 may provide graphics in the touchscreen 218 that direct the individual through at least a portion of the commercial transaction. For example, the touchscreen 218 may prompt answers from the individual (e.g., “What brand of cigarettes would you like?”). As another example, the touchscreen 218 may also display the brand logos of the products to the individual and the individual can identify the product that he or she wishes to purchase by pressing on the logo.

Before or after the product-selection stage, the vending system 200 may compare a personal image of the individual that is found on an identification card, such as a driver's license or passport, to the present image that is obtained by the imaging system 215. During an image-acquisition stage, the individual positions himself or herself proximate to the operative side 201 so that the person's body and, more particularly, face is the view of the imaging system 215. The imaging system 215 is configured to capture visual data when the individual is positioned proximate to the operative side 201. The visual data may include a present image of the individual and a card image of the identification card. The identification card includes a personal image of a person. In other words, the card image includes the personal image in addition to other information viewable on the identification card (e.g., license number, date of birth, height, weight, and the like). The personal image may be a portrait image of a person's face, such as the portrait images that are frequently provided with a driver's license and passport. The portrait images may be the personal images that are analyzed by the imaging system 215. The portrait image may include watermarks or other features that are associated with the type of identification card.

The computing system 110 is configured to analyze the visual data to determine whether the person in the personal image is the individual positioned proximate to the operative side 201. For example, the image-analysis module 131 may use a facial-recognition algorithm or software to identify a location and orientation of the individual's head and analyze the present image. The analysis may include comparing identifiable features of the individual's face (e.g., position and shape of the individual's nose, ears, eyes, eyebrows, cheekbones, hair line, complexion, and the like) to corresponding features of the person in the personal image. The image-analysis module 131 may generate a similarity score based on the comparison. The similarity score may represent the likelihood that the individual in the present image is the same person in the personal image. If the similarity score exceeds a designated amount, the image-analysis module 131 may determine that the individual in the present image is also the individual in the personal image.

Before, after, or during the above body/facial analysis, the computing system 110 may also determine whether the individual is permitted to purchase the controlled product. In some embodiments, the computing system 110 may locate a date of birth in the card image and determine, based on the age of the individual, whether the person is permitted to purchase the controlled product. Alternatively or in addition to the age determination, the image-analysis module 131 may locate and determine a name of the individual or other identifying information. Using this information, the computing system 110 may request personal data from a database, such as from the storage device 136 or from a remote database, to determine whether the person is permitted to purchase the controlled product. For example, the database may include a list of individuals and corresponding personal information that may be used to determine whether the person is permitted to purchase the controlled product. For example, the personal information may include or be based on a criminal or mental history of the individual. In such embodiments where only a limited amount of a controlled product may be sold to a person, the database may include information that identifies how much of the controlled product that the individual has purchased in a designated time period.

In some embodiments, the customer display 214 shows at least one of the video or an image frame to the individual during the image-acquisition stage in which the present image is obtained. The image-analysis module 131 may analyze the at least one of the video or the image frame to determine if an identifying portion of the individual (e.g., a head) is oriented suitably for capturing the present image. In some embodiments, in order to obtain a present image that is comparable to the personal image of the identification card, the image-analysis module 131 may analyze data obtained by the imaging system 215 and request the individual to re-position (or re-orient) his or her body to obtain the comparable image. The requests may be displayed by the user interface 212. For example, the customer display 214 may include graphical features that direct the individual in a desired manner. More specifically, the graphical features may include arrows that indicate how the individual should turn his or her head. The graphical features may be overlaid the image. The graphical features may also include video of a representative head (e.g., a head other than the head of the individual) performing the motion that is desired by the image-analysis module 131. For instance, the video may repeatedly show a person's head looking up or turning sideways. Once the individual has suitably re-positioned his or her head, the user interface 212 may indicate to the individual that the positioning is correct and/or a present image has been captured. For example, the user interface 212 may provide a flashing light, a flashing sound, a click sound, or any other visual, audible, or tactile indication.

In some embodiments, the vending system 200 may offer a variety of payment methods that are controlled by the payment-verification module 133. For example, the vending system 200 may accept payment through credit cards and/or a codex algorithm. With respect to a credit card purchase, the payment-verification module 133 may direct the individual through the user interface 212 on how to proceed with payment using a credit card. For example, the user interface 212 may request that the individual swipe his or her credit card through a card reader 250. The user interface 212 may request security information (e.g., a PIN number or the zip code of the billing address of the cardholder) from the individual.

The vending system 200 may also use a near-field communication device 252 to receive payment from the individual. The near-field communication device 252 may be similar to the near-field communication device 126 described above. For instance, the near-field communication device 252 may be configured to communicate with a portable electronic device (e.g., phone, tablet computer, notebook computer). The near-field communication device 252 may communicate wirelessly (e.g., via radio waves) with the portable electronic device. The near-field communication device 252 may be configured to receive transactional data from the portable electronic device for completing a commercial transaction to purchase the product. The payment may be made according to an established or recognizable mobile payment protocol or system, such as Google Wallet™.

In some embodiments, the near-field communication device 252 may include an imager (e.g., CMOS or CCD camera) that is configured to capture an image of the electronic device. The image of the electronic device may include an encoded feature that represents at least a portion of the transactional data that is necessary for carrying out the commercial transaction. By way of example only, the electronic device may have a device display that shows a barcode (e.g., conventional bar code or QR code). The electronic device may also have physical or visible features that are located on the housing of the electronic device and provide at least a portion of the transactional data.

In some embodiments, the data-analysis module 132 and the sales-recording module 134 are used to at least one of collect, filter, or analyze data that is obtained by the vending system 200. For instance, the data may be sales data, such as a number of items remaining for each product, a number of items remaining in a category of products, a time period in which a number of products were purchased. The sales-recording module 134 may record and store the sales data. The data-analysis module 132 and/or the sales-recording module 134 may be used to determine that (a) a product-of-interest is sold out or has only a limited number remaining for sale; (b) a certain amount of tax is owed for sales of the commercial products; or (c) a price of a product-of-interest should be updated based on a number of sales of the product-of-interest in a designated time period. When an operator (e.g., a product deliverer or a technician) communicates with the vending system 200, the vending system 200 may provide sales data to the operator. The operator may use the data to determine how much, if any, of a certain product should be stocked with the vending system 200.

In some embodiments, the vending system 200 may communicate with other vending systems 200 that are adjacent or nearby. For example, if a first vending system 200 is transported next to a second vending system 200, the first and second vending systems 200 may collectively use their data to determine how much of a product should be stored in the first and second vending systems. As a specific example, if the first vending system 200 sells a total of 100 items of Product A in one week alone (e.g., without the second vending system being present), then the first and second vending systems may be stocked to have a total of 100 items of the Product A between the two of them.

As described above, the various components and modules described herein may be implemented as part of one or more computers or processors. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor. The instructions may be stored on a tangible and/or non-transitory computer readable storage medium coupled to one or more servers.

As used herein, the term “computer” or “computing system” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer” or “computing system.”

The set of instructions may include various commands that instruct the computer or processor as a processing machine to perform specific operations such as the methods and processes described herein. The set of instructions may be in the form of a software program. The software may be in various forms such as system software or application software. Further, the software may be in the form of a collection of separate programs, a program module within a larger program, or a portion of a program module. The software also may include modular programming in the form of object-oriented programming. The processing of input data by the processing machine may be in response to user commands, or in response to results of previous processing, or in response to a request made by another processing machine. The program is complied to run on both 32-bit and 64-bit operating systems. A 32-bit operating system like Windows XP™ can only use up to 3 GB bytes of memory, while a 64-bit operating system like Window's Vista™ can use as many as 16 exabytes (16 billion GB).

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A vending system comprising:
a machine housing having an operative side configured to interface with an individual;
a product dispenser supported by the machine housing and configured to dispense a controlled product;
an imaging system configured to capture visual data when the individual is positioned proximate to the operative side, the visual data including a present image of the individual and a card image of the identification card, the identification card including a personal image of a person; and
a computing system configured to analyze the visual data to determine whether the person in the personal image is the individual positioned proximate to the operative side, the computing system also configured to determine whether the individual is permitted to purchase the controlled product.

2. The vending system of claim 1, wherein the personal image includes a face of the person and the present image includes a face of the individual.

3. The vending system of claim 1, further comprising a customer display that is configured to be viewed by the individual, the customer display configured to show at least one of a graphical user interface (GUI) element, an image frame of the individual, or a video of the individual.

4. The vending system of claim 3, wherein the customer display shows at least one of the video or the image frame to the individual during an image-acquisition stage in which the present image is acquired.

5. The vending system of claim 4, wherein the customer display is configured to shows commands to the individual during the image-acquisition stage, the commands instructing the individual to re-position an identifying portion of the individual.

6. The vending system of claim 3, wherein the customer display is configured to indicate to the individual that the present image has been obtained.

7. The vending system of claim 3, further comprising a scanner configured to acquire the personal image of the identification card when the identification card is pressed against the customer display.

8. A method of verifying that an individual is permitted to purchase a controlled product at a vending system, the method comprising:
acquiring visual data of the individual that is positioned proximate to an operative side of the vending system, the visual data including a present image of the individual and an identification card, the identification card including a personal image of a person;
analyzing the visual data to determine whether the person in the personal image is the individual positioned proximate to the operative side; and
determining whether the individual is permitted to purchase the controlled product.

9. The method of claim 8, wherein the personal image includes a face of the person and the present image includes a face of the individual.

10. The method of claim 8, further comprising showing to the individual at least one of a graphical user interface (GUI) element, an image frame of the individual, or a video of the individual.

11. The vending system of claim 1, further comprising requesting that the individual position the identification card immediately adjacent to a scanner screen.

12. A vending system comprising:
a machine housing having an operative side configured to interface with an individual;
a product dispenser supported by the machine housing and configured to dispense a commercial product;
a near-field communication device configured to communicate with a portable electronic device of the individual, wherein the near-field communication device is configured to receive transactional data from the portable electronic device for completing a commercial transaction to purchase the controlled product; and
a payment-verification module configured to communicate with a financial entity to confirm payment of the transaction.

13. The vending system of claim 12, wherein the near-field communication device includes an imager configured to capture an image of the electronic device, the electronic device including an encoded feature that represents the transactional data.

14. The vending system of claim 13, wherein the encoded feature is a bar code.

15. The vending system of claim 13, wherein the near-field communication device is configured to communicate wirelessly with the electronic device.

16. The vending system of claim 14, wherein the near-field communication device is configured to communicate with the electronic device through radio signals.

17. A vending system comprising:
a machine housing having an operative side configured to interface with individuals during transactions in which commercial products are sold to the individuals;
a product dispenser supported by the machine housing and configured to dispense the commercial products to the individuals;
a sales-recording module configured to store sales data relating to the commercial products sold through the transactions;
a data-analysis module configured to analyze the sales data, the data-analysis module configured to determine at least one of:
(a) whether a first product-of-interest is sold out or has only a limited number remaining for sale;
(b) an amount of tax owed for sales of the commercial products; and
(c) an updated price of a second product-of-interest based on a number of sales of the second product-of-interest in a designated time period.

18. The vending system of claim 17, wherein the data-analysis module is configured to notify an operator of the vending system that the first product-of-interest is sold out or has only a limited number remaining for sale.

19. The vending system of claim 17, wherein the data-analysis module is configured to communicate to an operator of the vending system the amount of tax owed for the sales of the commercial products.
